(19) United States
(12) Patent Application Publication
(10) Pub. No.: US 2016/0247520 A1
(43) Pub. Date: Aug. 25, 2016

(54) ELECTRONIC APPARATUS, METHOD, AND PROGRAM

(71) Applicant: KABUSHIKI KAISHA TOSHIBA, Tokyo (JP)

(72) Inventor: Yusaku KIKUGAWA, Nishitama Tokyo (JP)

(21) Appl. No.: 14/919,662

(22) Filed: Oct. 21, 2015

(30) Foreign Application Priority Data
Feb. 25, 2015 (JP) 2015-035353

(51) Int. Cl. G10L 21/10; G06F 3/16; G10L 15/26

(52) U.S. Cl. CPC G10L 21/10; G10L 15/26; G06F 3/167

(57) ABSTRACT

In general, according to one embodiment, an electronic apparatus displays a first object indicating a first speech zone and a second object indicating a second speech zone during recording, displays a first character string and a second character string corresponding to speech recognition of the first and the second speech zones. At least a part of the first speech zone and at least a part of the second speech zone are speech-recognized in an order of priority defined in accordance with display positions of the first object and the second object on the screen.

### CROSS-REFERENCE TO RELATED APPLICATIONS

This application is based upon and claims the benefit of priority from Japanese Patent Application No. 2015-035353, filed Feb. 25, 2015, the entire contents of which are incorporated herein by reference.

### FIELD

Embodiments described herein relate generally to visualization of speech during recording.

### BACKGROUND

Conventionally, there has been a demand for visualizing speech during recording when it is to be recorded by an electronic apparatus. As an example, an electronic apparatus which analyzes input sound, and displays the sound by discriminating between a speech zone in which a person utters words and a non-speech zone other than the speech zone (i.e., a noise zone or a silent zone) is available.

According to a conventional electronic apparatus, though a speech zone indicating that a speaker is speaking can be displayed, the substance of the speech cannot be visualized.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a plan view showing an example of an appearance of an embodiment.

FIG. 2 is a block diagram showing an example of a system configuration of the embodiment.

FIG. 3 is a block diagram showing an example of a functional configuration of a voice recorder application of the embodiment.

FIG. 4 is an illustration showing an example of a home view of the embodiment.

FIG. 5 is an illustration showing an example of a recording view of the embodiment.

FIG. 6 is an illustration showing an example of a playback view of the embodiment.

FIG. 7 is an illustration showing an example of a functional configuration of a speech recognition engine of the embodiment.

FIG. 8A is an illustration showing an example of speech enhancement processing of the embodiment.

FIG. 8B is an illustration showing another example of speech enhancement processing of the embodiment.

FIG. 9A is an illustration showing an example of speech determination processing of the embodiment.

FIG. 9B is an illustration showing another example of speech determination processing of the embodiment.

FIG. 10A is a diagram showing an example of an operation of a queue of the embodiment.

FIG. 10B is a diagram showing another example of an operation of a queue of the embodiment.

FIG. 11 is a diagram showing another example of the recording view of the embodiment.

FIG. 12 is a flowchart showing an example of an operation of the embodiment.

FIG. 13 is a flowchart showing an example of an operation of part of speech recognition in the flowchart of FIG. 12.

### DETAILED DESCRIPTION

Various embodiments will be hereinafter described with reference to the accompanying drawings. In general, according to one embodiment, an electronic apparatus is configured to record a sound from a microphone and recognize a speech. The apparatus includes a receiver configured to receive a sound signal from the microphone, wherein the sound comprises a first speech period and a second speech period; and circuitry. The circuitry is configured to (i) display on a screen a first object indicating the first speech period, and a second object indicating the second speech period after the first speech period during recording of the sound signal; (ii) perform speech recognition on the first speech period to determine a first character string comprising the characters in the first speech period; (iii) display the first character string on the screen in association with the first object; (iv) perform speech recognition on the second speech period to determine a second character string comprising the characters in the second speech period; (v) display the second character string on the screen in association with the second object; and (vi) perform speech recognition on at least a part of the first speech period and at least a part of the second speech period in an order of priority based on display positions of the first object and the second object on the screen.

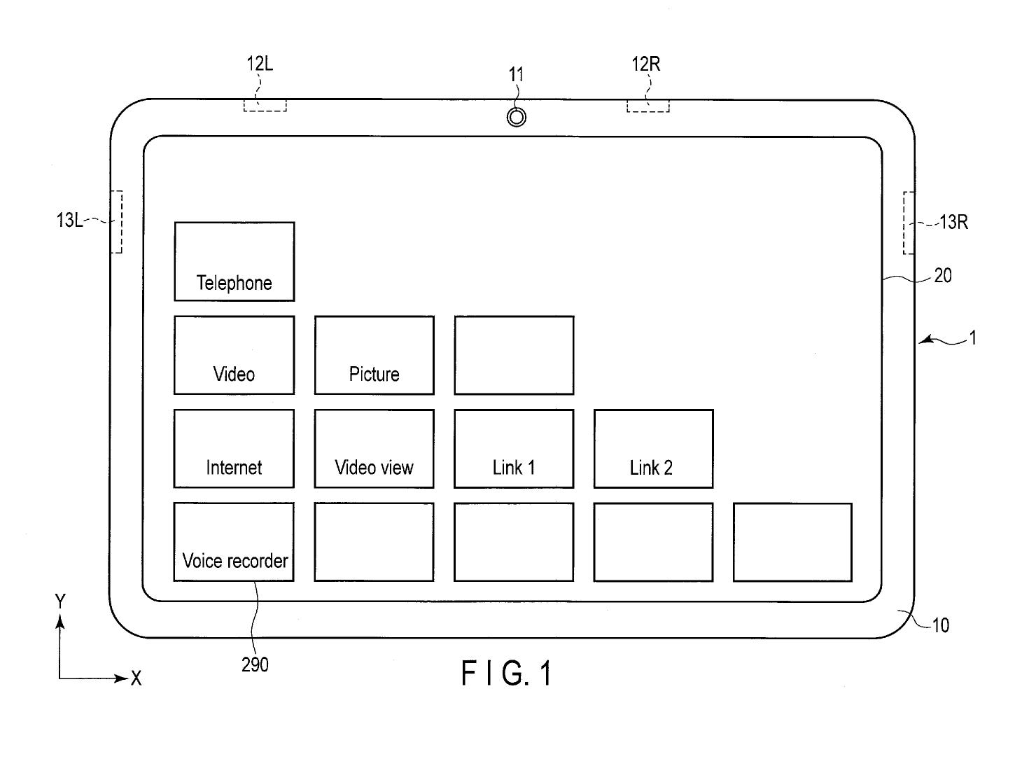

FIG. 1 shows a plan view of an example of an electronic apparatus 1 according to an embodiment. The electronic apparatus 1 is, for example, a tablet-type personal computer (a portable personal computer (PC)), a smart phone, or a personal digital assistant (PDA). Here, the case where the electronic apparatus 1 is a tablet-type personal computer will be described. Each of the elements or structures described below can be realized by using hardware or can be realized by using software which employs a microcomputer (a processor or a central processing unit (CPU)).

The tablet-type personal computer (hereinafter abbreviated as “tablet PC”) 1 includes a main body 10 and a touch screen display 20.

A camera 11 is arranged at a predetermined position in the main body 10, that is, at a central position in an upper end of a surface of the main body 10, for example. Further, at two predetermined positions in the main body 10, that is, at two positions which are separated from each other in the upper end of the surface of the main body 10, for example, microphones 12R and 12L are arranged. A camera 11 may be disposed between these two microphones 12R and 12L. Note that the number of microphones to be provided may be one. At other two predetermined positions in the main body 10, that is, on a left side surface and a right side surface of the main body 10, for example, loudspeakers 13R and 13L are arranged. Although not shown in the drawings, a power switch (a power button), a lock mechanism, an authentication unit, etc., are disposed at yet other predetermined positions in the main body 10. The power switch controls on and off of power for allowing use of the tablet PC 1 (i.e., for activating the tablet PC 1). The lock mechanism locks an operation of the power switch when the tablet PC 1 is carried, for example. The authentication unit reads (biometric) information which is associated with the user's finger or palm for authenticating the user, for example.

The touch screen display 20 includes a liquid crystal display (LCD) 21 and a touch panel 22. The touch panel 22 is arranged on the surface of the main body 10 to cover a screen of the LCD 21. The touch screen display 20 detects a contact position of an external object (a stylus or finger) on a display screen. The touch screen display 20 may support a multi-touch function capable of detecting contact positions at the same time. The touch screen display 20 can display several icons for starting various application programs on the screen. These icons may include an icon 290 for starting a voice recorder program. The voice recorder program includes the function of visualizing the substance of recording made in a meeting, for example.

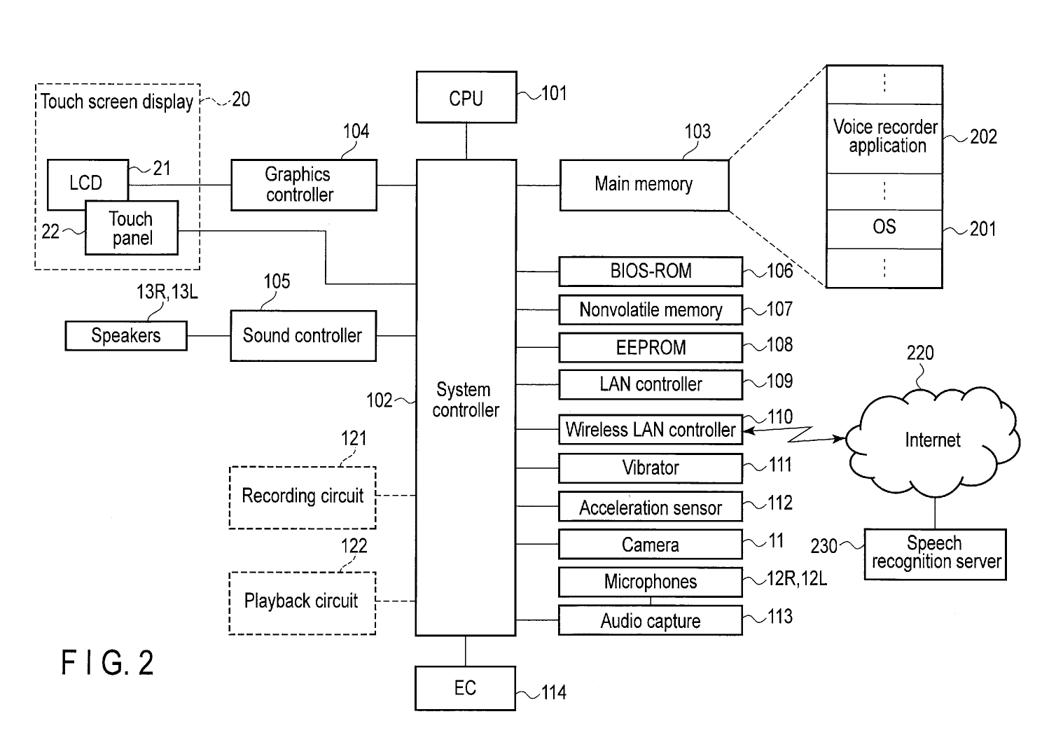

FIG. 2 shows an example of a system configuration of the tablet PC 1. Besides the elements shown in FIG. 1, the tablet PC 1 includes a CPU 101, a system controller 102, a main memory 103, a graphics controller 104, a sound controller 105, a BIOS-ROM 106, a nonvolatile memory 107, an EEPROM 108, a LAN controller 109, a wireless LAN controller 110, a vibrator 111, an acceleration sensor 112, an audio capture 113, an embedded controller (EC) 114, etc.

The CPU 101 is a processor circuit configured to control the operation of each of the elements in the tablet PC 1. The CPU 101 executes various programs loaded into the main memory 103 from the nonvolatile memory 107. These programs include an operating system (OS) 201 and various application programs. These application programs include a voice recorder application 202.

Some of the features of the voice recorder application 202 will be described. The voice recorder application 202 can record audio data corresponding to sound input via the microphones 12R and 12L. The voice recorder application 202 can extract speech zones from the audio data, and classify these speech zones into clusters corresponding to speakers in this audio data. The voice recorder application 202 has a visualization function of displaying each of the speech zones by speaker by using the result of cluster classification. By this visualization function, it is possible to present, in a user-friendly way, when and by which speaker the utterance is given. The voice recorder application 202 supports a speaker selection playback function of continuously playing back only the speech zones of the selected speaker. Further, the input sound can be subjected to speech recognition processing per speech zone, and the substance (text) of the speech zone can be presented in a user-friendly way.

Each of these functions of the voice recorder application 202 can be realized by a circuit such as a processor. Alternatively, these functions can also be realized by dedicated circuits such as a recording circuit 121 and a playback circuit 122.

The CPU 101 executes a Basic Input/Output System (BIOS), which is a program for hardware control, stored in the BIOS-ROM 106.

The system controller 102 is a device connecting between a local bus of the CPU 101 and various components. In the system controller 102, a memory controller for access controlling the main memory 103 is integrated. The system controller 102 has the function of executing communication with the graphics controller 104 via a serial bus conforming to the PCI EXPRESS standard. In the system controller 102, an ATA controller for controlling the nonvolatile memory 107 is also integrated. Further, a USB controller for controlling various USB devices is integrated in the system controller 102. The system controller 102 also has the function of executing communication with the sound controller 105 and the audio capture 113.

The graphics controller 104 is a display controller configured to control the LCD 21 of the touch screen display 20. A display signal generated by the graphics controller 104 is transmitted to the LCD 21. The LCD 21 displays a screen image based on the display signal. The touch panel 22 covering the LCD 21 serves as a sensor configured to detect a contact position of an external object on the screen of the LCD 21. The sound controller 105 is a sound source device. The sound controller 105 converts the audio data to be played back into an analog signal, and supplies the analog signal to the loudspeakers 13R and 13L.

The LAN controller 109 is a cable communication device configured to execute cable communication conforming to the IEEE 802.3 standard, for example. The LAN controller 109 includes a transmitter circuit configured to transmit a signal and a receiving circuit configured to receive a signal. The wireless LAN controller 110 is a wireless communication device configured to execute wireless communication conforming to the IEEE 802.11 standard, for example, and includes a transmitter circuit configured to wirelessly transmit a signal and a receiving circuit configured to wirelessly receive a signal. The wireless LAN controller 110 is connected to the Internet 220 via a wireless LAN or the like that is not shown, and performs speech recognition processing with respect to the sound input from the microphones 12R and 12L in cooperation with a speech recognition server 230 connected to the Internet 220.

The vibrator 111 is a vibrating device. The acceleration sensor 112 detects the current orientation of the main body 10 (i.e., whether the main body 10 is in portrait or landscape orientation). The audio capture 113 performs analog/digital conversion for the sound input via the microphones 12R and 12L, and outputs a digital signal corresponding to this sound. The audio capture 113 can send information indicative of which sound from the microphones 12R and 12L has a higher sound level to the voice recorder application 202. The EC 114 is a one-chip microcontroller for power management. The EC 114 powers the tablet PC 1 on or off in accordance with the user's operation of the power switch.

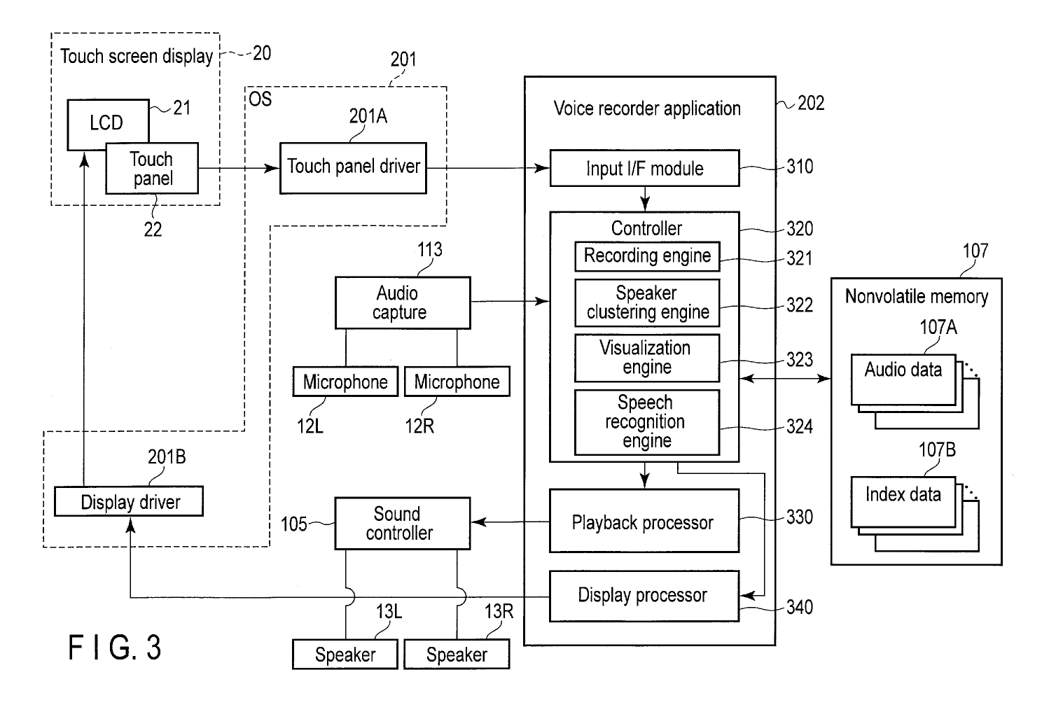

FIG. 3 shows an example of a functional configuration of the voice recorder application 202. The voice recorder application 202 includes an input interface I/F module 310, a controller 320, a playback processor 330, and a display processor 340 as the functional modules of the program.

The input interface I/F module 310 receives various events from the touch panel 22 via a touch panel driver 201A. These events include a touch event, a move event, and a release event. The touch event is an event indicating that an external object has touched the screen of the LCD 21. The touch event includes coordinates indicative of a contact position of the external object on the screen. The move event indicates that a contact position has moved while the external object is touching the screen. The move event includes coordinates of a contact position of a moving destination. The release event indicates that contact between the external object and the screen has been released. The release event includes coordinates indicative of a contact position where the contact has been released.

Finger gestures as described below are defined based on these events.

Tap: To separate the user's finger in a direction which is orthogonal to the screen after the finger has contacted an arbitrary position on the screen for a predetermined time. (Tap is sometimes treated as being synonymous with touch.)

Swipe: To move the user's finger in an arbitrary direction after the finger has contacted an arbitrary position on the screen.

Flick: To move the user's finger in a sweeping way in an arbitrary direction after the finger has contacted an arbitrary position on the screen, and then to separate the finger from the screen.

Pinch: After the user has contacted the screen by two digits (fingers) on arbitrary positions on the screen, to change an interval between the two digits on the screen. In particular, the case where the interval between the digits is increased (i.e., the case of widening between the digits) may be referred to as a pinch-out, and the case where the interval between the digits is reduced (i.e., the case of compressing between the digits) may be referred to as a pinch-out.

The controller 320 can detect which finger gesture (tap, swipe, flick, pinch, etc.) is made and where on the screen the figure gesture is made based on various events received from the input interface I/F module 310. The controller 320 includes a recording engine 321, a speaker clustering engine 322, a visualization engine 323, a speech recognition engine 324, etc.

The recording engine 321 records audio data 107A corresponding to the sound input via the microphones 12L and 12R and the audio capture 113 in the nonvolatile memory 107. The recording engine 321 can handle recording in various scenes, such as recording in a meeting, recording in a telephone conversation, and recording in a presentation. The recording engine 321 can also handle recording of other kinds of audio source, which are input via an element other than the microphones 12L and 12R and the audio capture 113, such as a broadcast and music.

The speaker clustering engine 322 analyzes the recorded audio data 107A and executes speaker identification processing. The speaker identification processing detects when and by which speaker the utterance is given. The speaker identification processing is executed for each sound data sample having the time length of 0.5 seconds. That is, a sequence of audio data (recording data), in other words, a signal sequence of digital audio signals is transmitted to the speaker clustering engine 322 per sound data unit having the time length of 0.5 seconds (assembly of sound data samples of 0.5 seconds). The speaker clustering engine 322 executes the speaker identification processing for each of the sound data units. As can be seen, the sound data unit of 0.5 seconds is an identification unit for identifying the speaker.

The speaker identification processing may include speech zone detection and speaker clustering. The speech zone detection determines whether the sound data unit is included in a speech zone or in a non-speech zone other than the speech zone (i.e., a noise zone or a silent zone). While any of the publicly-known techniques may be used to discriminate between the speech zone and the non-speech zone, voice activity detection (VAD), for example, may be adopted for the determination. The discrimination between the speech zone and the non-speech zone may be executed in real time during the recording.

The speaker clustering identifies which speaker gave utterance included in the speech zones in the sequence from the starting point of the audio data to the end point of the same. That is, the speaker clustering classifies these speech zones into clusters corresponding to speakers included in this audio data. A cluster is a set of sound data units of the same speaker. The existing various methods may be used as the method for executing the speaker clustering. For example, in the present method, both the method of executing the speaker clustering by using a speaker position and the method of executing the speaker clustering by using a feature amount (an acoustic feature amount) of sound data may be used.

The speaker position indicates the position of individual speaker relative to the tablet PC 1. The speaker position can be estimated based on a difference between two sound signals input through the two microphones 12L and 12R. Each sound input from the same speaker position is assumed to be the sound of the same speaker.

In the method of executing the speaker clustering by using the feature amount of sound data, sound data units having the feature amounts similar to each other are classified as the same cluster (the same speaker). The speaker clustering engine 322 extracts the feature amount such as Mel Frequency Cepstrum Coefficients (MFCCs) from sound data units determined as being in the speech zone. The speaker clustering engine 322 can execute the speaker clustering by adding not only the speaker position of the sound data unit but also the feature amount of the sound data unit. While any of the existing methods can be used as the method of speaker clustering which uses the feature amount, the method described in, for example, JP 2011-191824A (JP 5174068B) may be adopted. Information representing a result of the speaker clustering is stored in the nonvolatile memory 107 as index data 107B.

The visualization engine 323 executes the processing of visualizing an outline of the whole sequence of the audio data 107A in cooperation with the display processor 340. More specifically, the visualization engine 323 displays a display area representing the whole sequence. Further, the visualization engine 323 displays each of the speech zones in the display area in question. If speakers exist, the speech zones are displayed in such a way that the speakers of these individual speech zones can be distinguished from each other. The visualization engine 323 can visualize the speech zones of their respective speakers by using the index data 107B.

The speech recognition engine 324 transmits the audio data of the speech zone after subjecting it to preprocessing to the speech recognition server 230, and receives a result of the speech recognition from the speech recognition server 230. The speech recognition engine 324 displays text, which is the recognition result, in association with the display of the speech zone on the display area by cooperating with the visualization engine 323.

The playback processor 330 plays back the audio data 107A. The playback processor 330 can continuously play back only the speech zones by skipping the silent zones. The playback processor 330 can also execute selected speaker playback processing of continuously playing back only the speech zones of a specific speaker selected by the user by skipping the speech zones of the other speakers.

Next, an example of several views (home view, recording view, playback view) displayed on the screen by the voice recorder application 202 will be described.

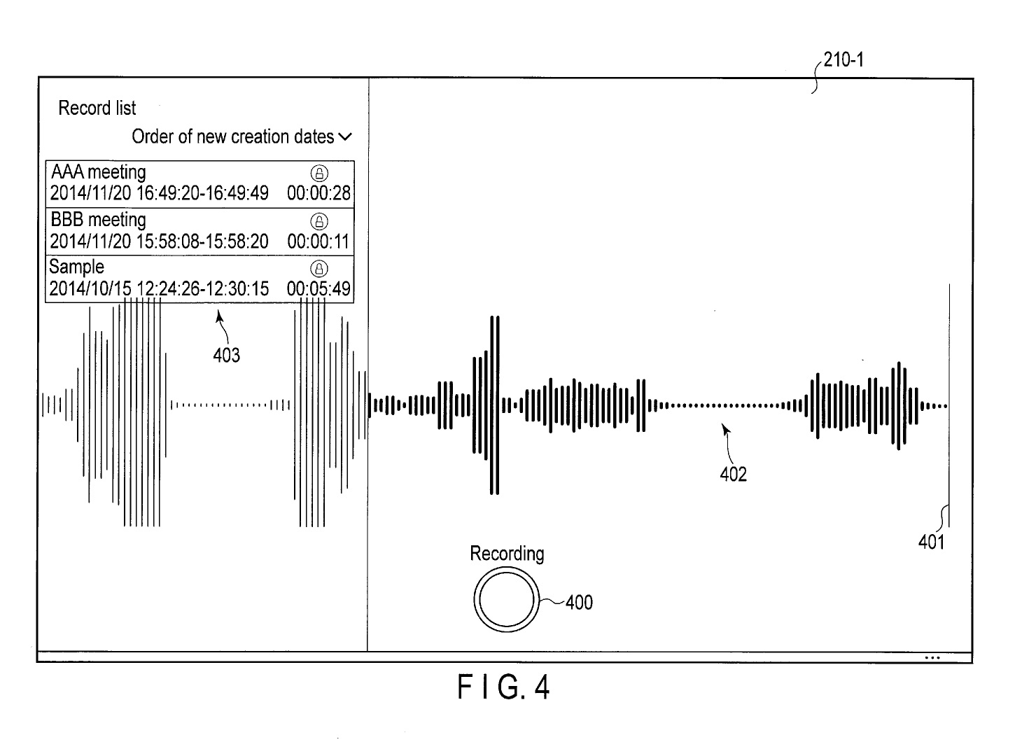

FIG. 4 shows an example of a home view 210-1. The voice recorder application 202 displays the home view 210-1 when the voice recorder application 202 is started. The home view 210-1 displays a recording button 400, a sound waveform 402 of a certain period of time (for example, 30 seconds), and a record list 403. The recording button 400 is a button for instructing the recording to be started.

The sound waveform 402 represents a waveform of a sound signal which is currently being input via the microphones 12L and 12R. The waveform of a sound signal appears one after another in real time at the position of a longitudinal bar 401 representing the current time. Further, as time elapses, the waveform of the sound signal moves to the left from the longitudinal bar 401. In the sound waveform 402, the continuous longitudinal bars have lengths corresponding to levels of power of continuous sound signal samples, respectively. By the display of the sound waveform 402, the user can confirm whether the sound is input normally before starting the recording.

The record list 403 includes records which are stored in the nonvolatile memory 107 as the audio data 107A. Here, the case where three records, which are the record titled “AAA meeting”, the record titled “BBB meeting”, and the record titled “Sample”, exist is assumed. In the record list 403, the recording date of the record, the recording time of the record, and the recording stop time of the record are also displayed. In the record list 403, the recording (the records) can be sorted in the order in which the creation date is new or old, or in the order of titles.

When a certain record in the record list 403 is selected by the user's tap operation, the voice recorder application 202 starts the playback of the selected record. When the recording button 400 of the home view 210-1 is tapped by the user, the voice recorder application 202 starts the recording.

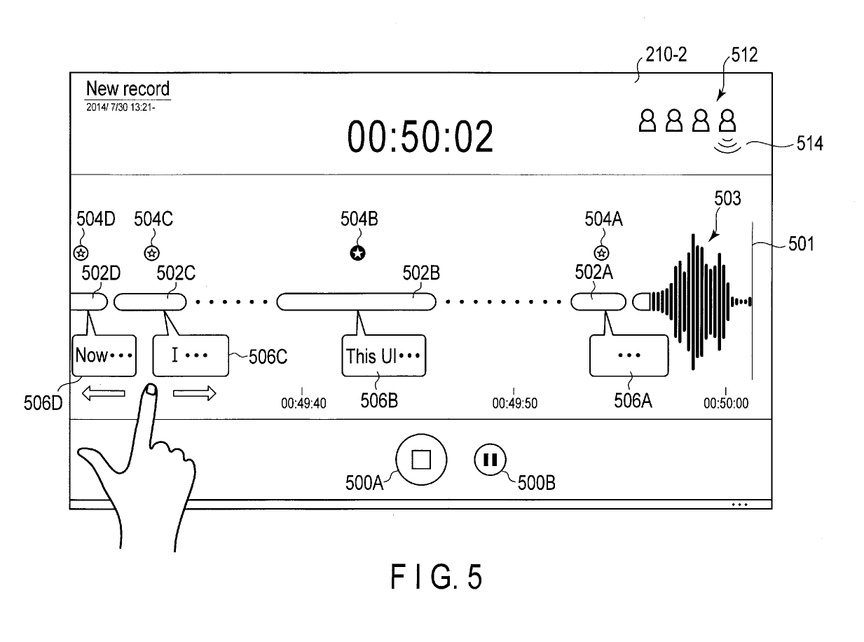

FIG. 5 shows an example of the recording view 210-2. When the recording button 400 is tapped by the user, the voice recorder application 202 starts the recording, and switches the display screen from the home view 210-1 shown in FIG. 4 to the recording view 210-2 shown in FIG. 5.

The recording view 210-2 displays a stop button 500A, a pause button 500B, a speech zone bar 502, a sound waveform 503, and a speaker icon 512. The stop button 500A is a button for stopping the current recording. The pause button 500B is a button for temporarily stopping the current recording.

The sound waveform 503 represents a waveform of a sound signal which is currently being input via the microphones 12L and 12R. Likewise the sound waveform 402 in the home view 210-1, the sound waveform 503 appears at the position of a longitudinal bar 501 one after another, and moves to the left as time elapses. Also in the sound waveform 503, the continuous longitudinal bars have lengths corresponding to levels of power of continuous sound signal samples, respectively.

During the recording, the above-described speech zone detection is executed. When it has been detected that one or more sound data units in the sound signal is the one included in the speech zone (i.e., the sound data unit in question is a human voice), the speech zone corresponding to the aforementioned one or more sound data units is visualized by the speech zone bar 502 as an object representing the speech zone. The length of the speech zone bar 502 varies according to the time length of the corresponding speech zone.

The speech zone bar 502 can be displayed after input speech has been analyzed and the speaker identification processing has been performed by the speaker clustering engine 322. Consequently, since the speech zone bar 502 cannot be displayed immediately after the recording, as in the home view 210-1, the sound waveform 503 is displayed. The sound waveform 503 is displayed at the right end in real time, and flows toward the left side of the screen as time elapses. After a lapse of some time, the sound waveform 503 is replaced by the speech zone bar 502. Although it is not possible to determine which of power generated by speech and power generated by noise the sound waveform 503 represents from the sound waveform 503 alone, it is possible to confirm that the recording is made for the human voice based on the display of the speech zone bar 502. Since the real-time sound waveform 503 and the speech zone bar 502 which starts from a slightly delayed timing are displayed on the same row, the user's eyes can stay on the same row, and useful information can be obtained with good visibility without shifting the gaze.

When the sound waveform 503 is replaced by the speech zone bar 502, the sound waveform 503 is not switched instantly, but is gradually switched from a waveform display to a bar display. In this way, the current power is displayed as the sound waveform 503 at the right end, and the display is flowed from right to left and updated. Since the waveform is continuously or seamlessly changed and converges into a bar, the user will not feel the display to be unnatural when he/she is observing it.

In the upper left side of the screen, the record name (the indication “New Record” in the initial state) and the date and time are displayed. In the upper central portion of the screen, the recording time (which may be an absolute time but here, an elapsed time from the start of recording) (for example, “00:50:02” indicating 00 hour, 50 minutes, 02 seconds) is displayed. In the upper right side of the screen, the speaker icons 512 are displayed. When the speaker who is now speaking is specified, a speech mark 514 is displayed under the icon of the corresponding speaker. At the place below the speech zone bar 502, a time axis graduated in increments of 10 seconds is displayed. FIG. 5 visualizes the speech for a certain period of time from the current time (the right end), that is, the speech of the last thirty seconds, for example. The further the speech zone bar 502 moves to the left, the older it becomes. This time period of thirty seconds can be changed.

Although the scale of the time axis of the home view 210-1 is constant, the scale of the time axis of the recording view 210-2 is variable. That is, by swiping the time axis right and left or pinching-in or pinching-out the time axis, the scale can be varied and the display time (the time period of thirty seconds in the example of FIG. 5) can be varied. Also, by flicking the time axis right and left, the time axis is moved right and left, which enables visualization of the speech recorded on a time earlier by a given length of time from a certain point of time in the past with the length of time kept constant.

Tags 504A, 504B, 504C, and 504D are displayed above the speech zone bars 502A, 502B, 502C, and 502D. The tags 504A, 504B, 504C, and 504D are for selecting the speech zone, and when they are selected, a display form of the tag is changed. A change in the display form of the tag means that the tag is selected. For example, the color, the size, or the contrast of the selected tag is changed. Selection of the speech zone by the tag is performed to specify the speech zone which should be played back preferentially at the time of playback, for example. Further, the selection of the speech zone by the tag is also used to control the order of processing of speech recognition. Normally, the speech recognition is carried out in turn in the order in which the speech zones are old, but a tagged speech zone is speech-recognized preferentially. In association with the speech zone bars 502A, 502B, 502C, and 502D, balloons 506A, 506B, 506C, and 506D displaying results of speech recognition are displayed under the corresponding speech zones bars, for example.

The speech zone bar 502 moves to the left in accordance with a lapse of time, and gradually disappears from the screen from the left end. Together with the above movement, the balloon 506 under the speech zone bar 502 also moves to the left, and disappears from the screen from the left end. While the speech zone bar 502D at the left end gradually disappears from the screen, the balloon 506D may also gradually disappear like the speech zone bar 502D or the balloon 506D may entirely disappear when it comes within a certain distance of the left end.

Since the size of the balloon 506 is limited, there are cases where the whole text cannot be displayed, and in that case, display of part of the text is omitted. For example, only the leading several characters which are the recognition result are displayed and the remaining part is omitted from the display. The omitted recognition result is displayed as “. . . ”. In this case, all of the recognition result may be allowed to be displayed by having a pop-up window displayed by clicking on the balloon 506, and displaying all of the recognition result in that pop-up window. The balloon 506A of the speech zone 502A is all displayed as “. . . ”, and this means that the speech could not be recognized. Also, if there is enough space in the overall screen, the size of the balloon 506 may be changed in accordance with the number of characters of the text. Alternatively, the size of the text may be changed in accordance with the number of characters displayed within the balloon 506. Further, the size of the balloon 506 may be changed in accordance with the number of characters obtained as a result of the speech recognition, the length of the speech zone, or the display position. For example, the width of the balloon 506 may be increased when there are many characters or the speech zone bar is long, or the width of the balloon 506 may be reduced as the display position comes to the left side.

Since the balloon 506 is displayed upon completion of the speech recognition processing, when the balloon 506 is not displayed, the user can know that the speech recognition processing is in progress or has not been started yet (unprocessed). Further, in order to distinguish between the “unprocessed” stage and the “being processed” stage, while no balloon 506 is displayed when the processing has not taken place; a blank balloon 506 may be displayed for the processing in progress. The blank balloon 506 showing that the processing is in progress may be blinked. Further, a difference between the “unprocessed” status and the “being processed” status of the speech recognition may be represented by a change in the display form of the speech zone bar 502, instead of representing it by a change in the display form of the balloon 506. For example, the color, the contrast, etc., of the speech zone bar 502 may be varied in accordance with the status.

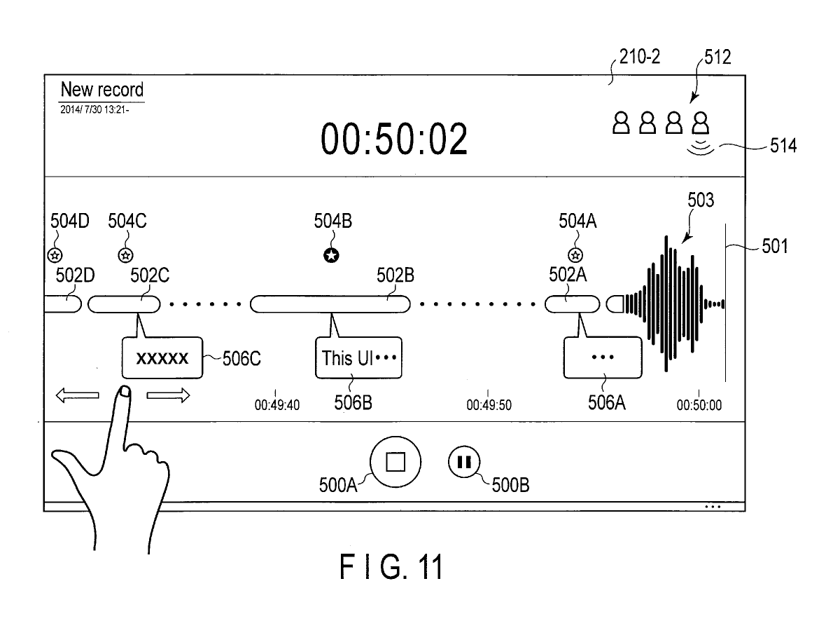

Although this will be described later, in the present embodiment, not all of the speech zones are subjected to speech recognition processing, but some of the speech zones are excluded from the speech recognition processing. Accordingly, when no speech recognition result is obtained, the user may want to know whether the recognition processing yielded no result or the recognition processing has not been performed. In order to deal with this demand, all of the balloons of the speech zones not subjected to the recognition processing may be made to display “xxxx”, although FIG. 5 does not show it. FIG. 11 shows this feature. A user interface regarding display of the aforementioned speech recognition result is a design matter and can be modified variously.

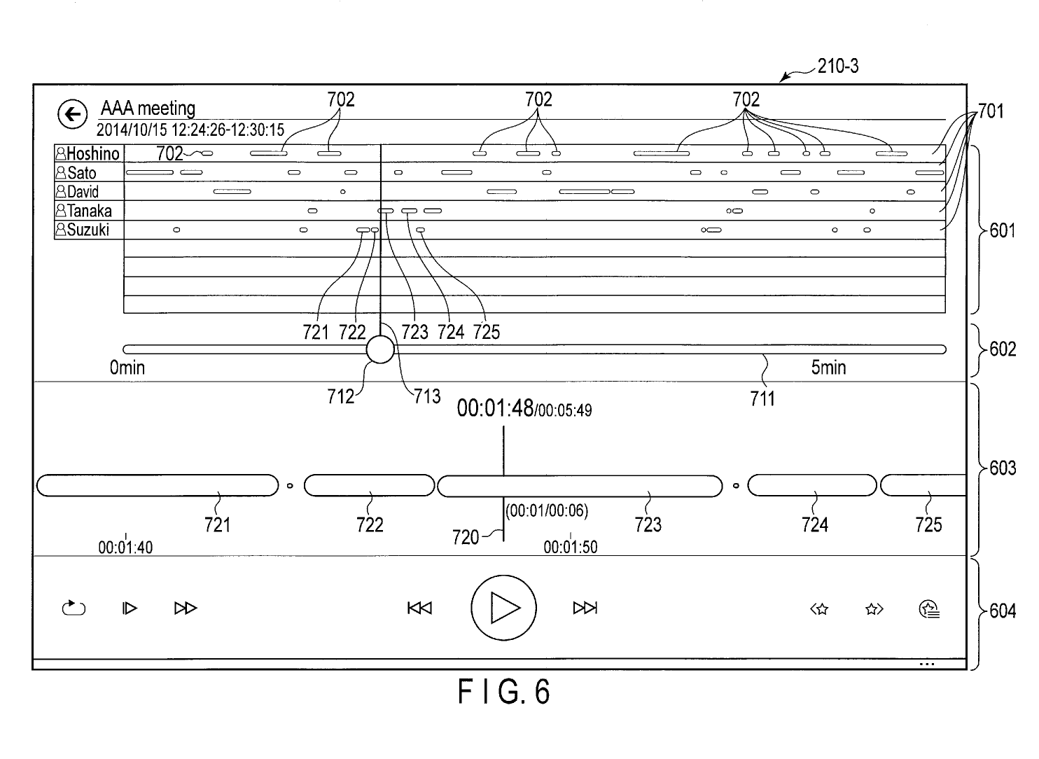

FIG. 6 shows an example of a playback view 210-3 in a state in which a playback of the record titled “AAA meeting” is temporarily stopped. The playback view 210-3 displays a speaker identification result view area 601, a seeking bar area 602, a playback view area 603, and a control panel 604.

The speaker identification result view area 601 displays the whole sequence of the record titled “AAA meeting”. The speaker identification result view area 601 may display time axes 701 corresponding to speakers in the sequence of the record, respectively. In the speaker identification result view area 601, five speakers are arranged in descending order of the amount of speech in the whole sequence of the record titled “AAA meeting”. The speaker who spoke most in the whole sequence is displayed at the top of the speaker identification result view area 601. The user can listen to each of the speech zones of a specific speaker by tapping the speech zone (a speech zone mark) of the specific speaker in order.

The left end of the time axis 701 corresponds to a start time of the sequence of the record, and the right end of the time axis 701 corresponds to an end time of the sequence of the record. That is, a total of time from start to end of the sequence of the record is assigned to the time axis 701. However, if the total time is long, when the total time is entirely assigned to the time axis, there are cases where the scale of the time axis becomes too small and the display becomes hard to see. In such a case, likewise the recording view, the size of the time axis 701 may be varied.

In the time axis 701 of a certain speaker, the positions of the speech zones of that speaker and the speech zone mark representing the time length are displayed. Different colors may be assigned to the speakers. In this case, speech zone marks having different colors for their respective speakers may be displayed. For example, in the time axis 701 of the speaker “Hoshino”, speech zone marks 702 may be displayed in a color (for example, red) assigned to the speaker “Hoshino”.

The seeking bar area 602 displays a seeking bar 711, and a movable slider (also referred to as a locator) 712. The total of time from start to end of the sequence of the record is assigned to the seeking bar 711. A position of the slider 712 on the seeking bar 711 represents the current playback position. A longitudinal bar 713 extends upward from the slider 712. Since the longitudinal bar 713 traverses the speaker identification result view area 601, the user can easily understand which speech zone of the (main) speaker corresponds to the current playback position.

The position of the slider 712 on the seeking bar 711 moves rightward as the playback advances. The user can move the slider 712 rightward or leftward by a drag operation. In this way, the user can change the current playback position to an arbitrary position.

The playback view area 603 is a view for enlarging a period (for example, a period of 20 seconds or so) near the current playback position. The playback view area 603 includes a display area which is elongated in the direction of the time axis (here, the lateral direction). In the playback view area 603, several speech zones (the actual speech zone which have been detected) included in the period near the current playback position are displayed in chronological order. A longitudinal bar 720 represents the current playback position. When the user flicks the playback view area 603, the display of the playback view area 603 is scrolled left or right with the position of the longitudinal bar 720 fixed. As a result, the current playback position is also changed.

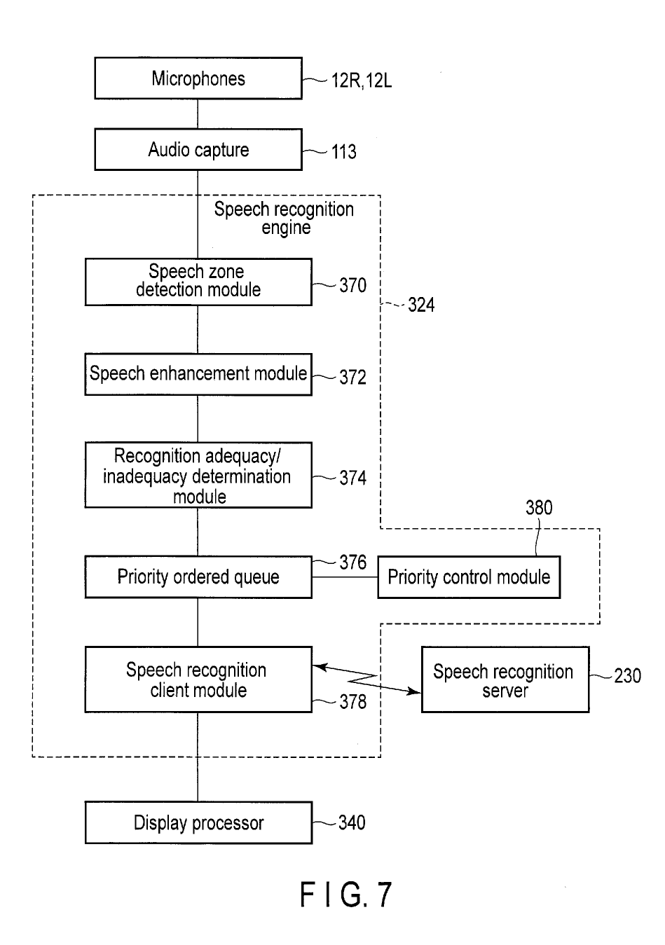

FIG. 7 is a diagram showing an example of a configuration of the speech recognition engine 324 shown in FIG. 3. The speech recognition engine 324 includes a speech zone detection module 370, a speech enhancement module 372, a recognition adequacy/inadequacy determination module 374, a priority ordered queue 376, a priority control module 380, and a speech recognition client module 378.

Audio data from the audio capture 113 is input to the speech zone detection module 370. The speech zone detection module 370 performs speech zone detection (VAD) for the audio data, and extracts speech zones in units of the upper limit time (for example, ten-odd seconds), on the basis of a result of discrimination between speech and non-speech (where noise and silence are included in non-speech). The audio data is assumed to be a speech zone per speech (utterance) or for every intake of breath. As regards the speech, a timing of change from silence to sound and a timing at which the sound is changed to silence again are detected, and an interval between these two timings may be defined as a speech zone. If this interval is longer than ten-odd seconds, the interval is reduced to ten-odd seconds considering the character unit. The reason why the upper limit time is set is because of a load on the speech recognition server 230. Generally, long hours of recognition of speech in a meeting and the like has problems as described below.

1) Since the recognition accuracy depends on a dictionary, it is necessary to store vast amounts of dictionary data in advance.

2) According to a situation in which speech is acquired (for example, when the speaker is at a remote place), the recognition accuracy may be changed (lowered).

3) Since the amount of speech data becomes enormous in a long meeting, the recognition processing may take time.

In the present embodiment, the so-called server-type speech recognition system is assumed. Since the server-type speech recognition system is an unspecified speaker type system (i.e., learning is unnecessary), there is no need to store vast amounts of dictionary data in advance. However, since the server is put under a load in the server-type speech recognition system, there are cases where speech which is longer than ten-odd seconds or so cannot be recognized. Accordingly, the server-type speech recognition system is commonly used for only the purpose of voice-inputting a search keyword, and it is not suitable for recognizing a long-duration (for example, one to three hours) speech, such as speech in a meeting.

In the present embodiment, the speech zone detection module 370 divides a long-duration speech into speech zones of ten-odd seconds or so. In this way, since the long-duration speech in a meeting is divided into a large number of speech zones of ten-odd seconds or so, speech recognition by the server-type speech recognition system is enabled.

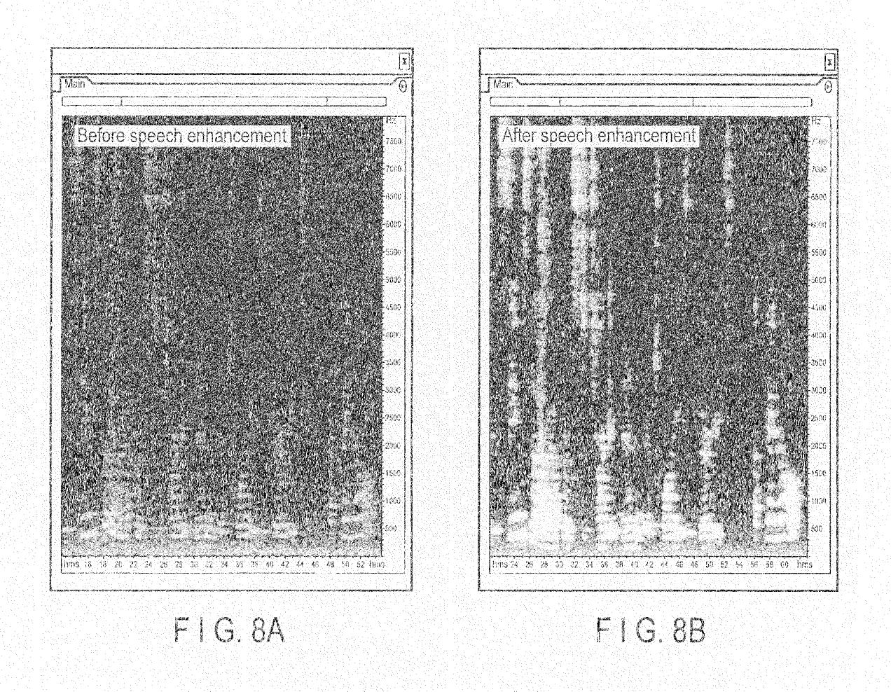

Speech zone data is subjected to processing by the speech enhancement module 372 and the recognition adequacy/inadequacy determination module 374, and is converted into speech zone data suitable for the server-type speech recognition system. The speech enhancement module 372 performs the processing which emphasizes vocal component with respect to the speech zone data, that is, for example, noise suppressor processing and automatic gain control processing. By these kinds of processing, a phonetic property (a formant) is emphasized, as shown in FIGS. 8A and 8B, and this increases the possibility of having more accurate speech recognition in the subsequent processing. In FIGS. 8A and 8B, the horizontal axis represents time, and the vertical axis represents frequency. FIG. 8A shows speech zone data before emphasis, and FIG. 8B shows speech zone data after emphasis. As the noise suppressor processing and the automatic gain control processing, the existing methods can be used. Also, emphasis processing of speech components other than the noise suppressor processing and the automatic gain control processing, which is, for example, reverberation suppression processing, microphone array processing, and sound source separation processing can be adopted.

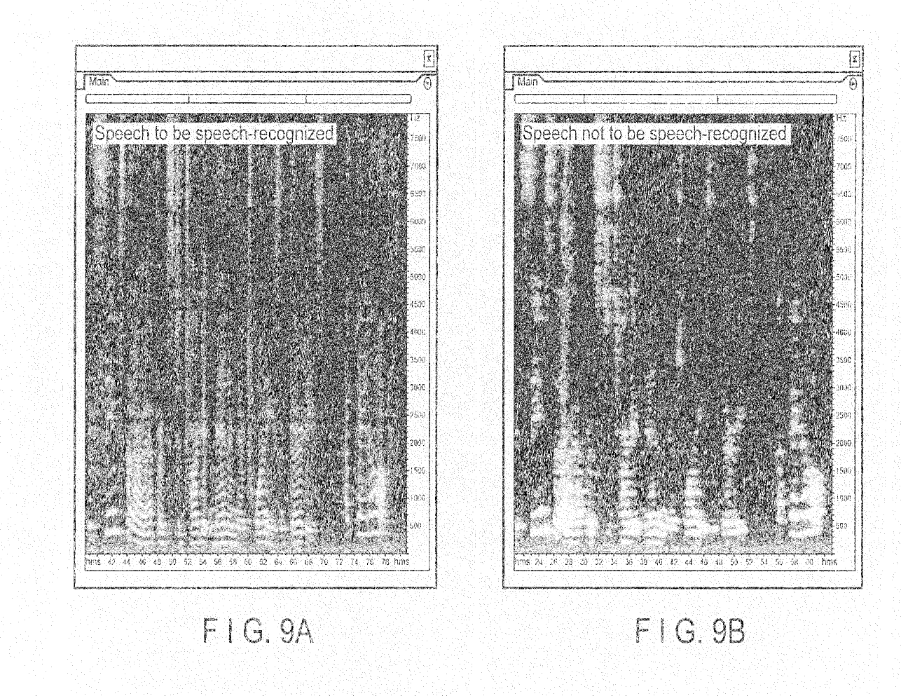

If a recording condition is bad (for example, the speaker is far away), since a vocal component itself is missing, restoration of a vocal component is not possible no matter how much the speech enhancement is performed, and speech recognition may not be accomplished. Even if speech recognition is carried out for such speech zone data, since the intended recognition result cannot be obtained, it will be a waste of processing time, as well as the processing of the server. Hence, an output of the speech enhancement module 372 is supplied to the recognition adequacy/inadequacy determination module 374, and the processing of excluding speech zone data which is not suitable for speech recognition is performed. For example, speech components of a low-frequency range (for example, a frequency range not exceeding approximately 1200 Hz) and speech components of a mid-frequency range (for example, a frequency range of approximately 1700 Hz to 4500 Hz) are observed. If a formant component exists in both of these ranges, as shown in FIG. 9A, it is determined that the speech zone data in question is the data suitable for speech recognition, and in the other cases, it is determined that the speech zone data in question is not suitable for speech recognition. FIG. 9B shows an example in which a mid-range frequency formant component is missing as compared to the low-frequency range case (i.e., the speech zone data is not suitable for speech recognition). The criteria for determining whether the speech zone data is adequate for recognition or not (i.e., recognition adequacy/inadequacy) is not limited to the above, and it is sufficient if data inadequate for speech recognition can be detected.

The speech zone data determined as being unsuitable for speech recognition is not output from the determination module 374, and only the speech zone data determined as being suitable for speech recognition is stored in the priority ordered queue 376. The processing time required for speech recognition is longer than the time required for detection processing of speech zones (i.e., it takes ten-odd seconds or so until the recognition result is output after the head of the speech zone has been detected). The speech zone data is stored in the queue 376 before subjecting it to speech recognition processing in order to absorb such a time difference. The priority ordered queue 376 is a first-in, first-out register, and basically, data is output in the order of input, but if priority is given by the priority control module 380, the data is output according to the given order of priority. The priority control module 380 controls the priority ordered queue 376 such that the speech zone whose tag 504 (FIG. 5) is selected is retrieved in preference to the other speech zones. Also, the priority control module 380 may control the order of priority among the speech zones in accordance with the display position of the speech zone. For example, since the speech zone at the left end of the screen disappears from the screen the most quickly, a judgment to skip the speech recognition for a speech zone near the left end, or a judgment not to display a balloon for the speech zone near the left end may be made. The recognition is controlled as described above so as to prevent the data from being accumulated excessively in the queue 376.

The speech zone data which has been retrieved from the priority ordered queue 376 is transmitted to the speech recognition server 230 via the wireless LAN controller 110 and the Internet 220 by the speech recognition client module 378. The speech recognition server 230 has an unspecified-speaker-type speech recognition engine, and transmits text data, which is a result of recognition of the speech zone data, to the speech recognition client module 378. The speech recognition client module 378 controls the display processor 340 to display the text data transmitted from the server 230 within the balloon 506 shown in FIG. 5.

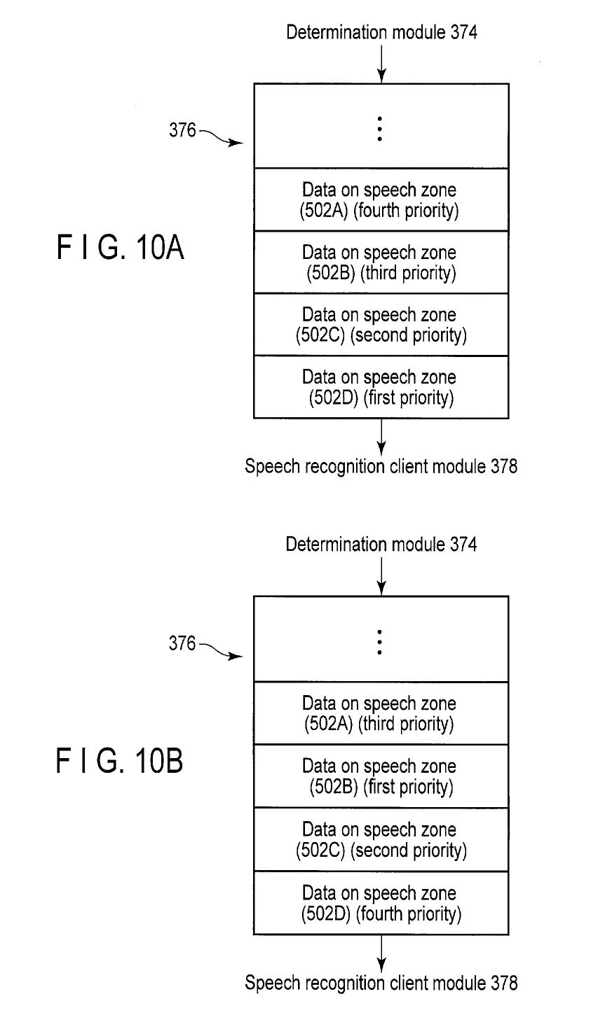

FIGS. 10A and 10B illustrate the way in which the speech zone data is retrieved from the priority ordered queue 376. FIG. 10A shows the way in which the speech zone data is retrieved from the priority ordered queue 376 when none of the tags 504A, 504B, 504C, and 504D of the four speech zones 502A, 502B, 502C, and 502D shown in FIG. 5 is selected, and the priority control module 380 does not in any way control (or change) the order of priority. In the priority ordered queue 376, data of the speech zone 502D, data of the speech zone 502C, data of the speech zone 502B, and data of the speech zone 502A are stored in the order in which they are old, and the order of storage is the same as the order of priority. That is, the speech zones 502D, 502C, 502B, and 502A are the first priority, second priority, third priority, and fourth priority, respectively, and the data is retrieved in the order of the data of the speech zone 502D, the data of the speech zone 502C, the data of the speech zone 502B, and the data of the speech zone 502A and speech-recognized. Accordingly, in the recording view 210-2 of FIG. 5, the balloons 506D, 506C, 506B, and 506A are displayed in the order of the speech zones 502D, 502C, 502B, and 502A.

FIG. 10B shows the way in which the speech zone data is retrieved from the priority ordered queue 376 when the priority control module 380 adjusts the order of priority. As shown in FIG. 5, since the tag 504B of the speech zone 502B is selected, the data of the speech zone 502B is given first priority among the data of the speech zone data 502D, the data of the speech zone 502C, the data of the speech zone 502B, and the data of the speech zone 502A which are stored in order in the priority ordered queue 376. Also, although the speech zone 502D is automatically given a high priority since it is the oldest, because the speech zone 502D is near the left end, it disappears from the screen soon. It is expected that even if speech recognition processing is performed, the speech zone 502D will already be cleared from the screen by the time the recognition result is obtained. Accordingly, since the speech recognition is skipped for the speech zone near the left end, the data in the speech zone in question is not retrieved from the priority ordered queue 376.

FIG. 11 shows an example of the recording view 210-2 in the case where the speech zone data is retrieved from the priority ordered queue 376 as shown in FIG. 10B. The data of the speech zone 502B is speech-recognized the first, and then the data is speech-recognized in the order of the data of the speech zone 502C, the data of the speech zone 502A, and the data of the speech zone 502D. Here, the balloon 506C of the speech zone 502C all indicates “xxxx”, and this means that the data was unsuitable for speech recognition and was not speech-recognized. The balloon 506A of the speech zone 502A is all displayed as “. . . ”, and this means that a recognition result could not be obtained although the speech recognition processing was carried out. The order of priority of the speech zone 502D is the fourth, and the data of the speech zone 502D is read after the data of the speech zone 502A. However, when the data of the speech zone 502D is read, since the speech zone 502D is already moved to an area near the left end, the data in question is not retrieved from the priority ordered queue 376. Accordingly, the speech recognition is skipped and the balloon 506D is not displayed.

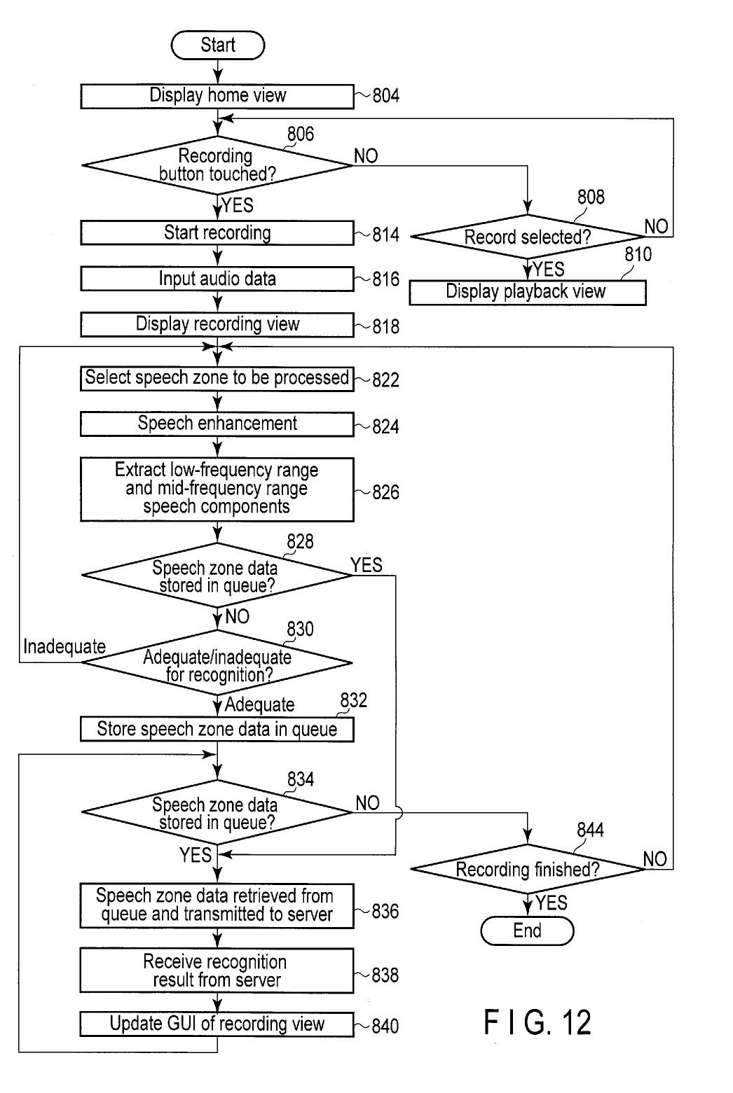

FIG. 12 is a flowchart showing an example of recording operation performed by the voice recorder application 202 of the embodiment. When the voice recorder application 202 is started, the home view 210-1 as shown in FIG. 4 is displayed in block 804. In block 806, it is determined whether the recording button 400 is operated or not. When the recording button 400 is operated, recording is started in block 814. When the recording button 400 is not operated in block 806, in block 808, it is determined whether a record in the record list 403 is selected or not. In block 808, when no record is selected, the determination of the recording button operation of block 806 is repeated. When a record is selected, a playback of the selected record is started in block 810, and the playback view 210-3 as shown in FIG. 6 is displayed.

When the recording is started in block 814, in block 816, audio data from the audio capture 113 is input to the voice recorder application 202. In block 818, speech zone detection (VAD) is performed for the audio data, speech zones are extracted, a waveform of the audio data and the speech zones are visualized, and the recording view 210-2 as shown in FIG. 5 is displayed.

When the recording is started, a large number of speech zones are input. In block 822, the oldest speech zone is selected as a target of processing. In block 824, the data of the speech zone in question is phonetic-property-emphasized (formant-emphasized) by the speech enhancement module 372. In block 826, low-frequency range speech components and mid-frequency range speech components of the data of the speech zone which have been emphasized are extracted by the recognition adequacy/inadequacy determination module 374.

In block 828, it is determined whether speech zone data is stored in the priority ordered queue 376. If speech zone data is stored, block 836 is executed. If speech zone data is not stored, the data of the speech zone whose low-frequency range speech components and mid-frequency range speech components are extracted in block 826 is determined whether it is suitable for speech recognition in block 830. For instance, if a formant component exists in both of the speech components of the low-frequency range (about 1200 Hz or less) and the mid-frequency range (about 1700 Hz to 4500 Hz), such data is determined as being suitable for speech recognition. When the data is determined as being inadequate for speech recognition, the processing returns to block 822, and the next speech zone is picked as the target of processing.

When the data is determined as being suitable for speech recognition, the data of this speech zone is stored in the priority ordered queue 376 in block 832. In block 834, it is determined whether speech zone data is stored in the priority ordered queue 376 or not. If speech zone data is not stored, it is determined whether the recording is finished in block 844. If the recording is not finished, the processing returns to block 822, and the next speech zone is picked as the target of processing.

When it is determined that speech zone data is stored in block 834, data of one speech zone is retrieved from the priority ordered queue 376 in block 836, and transmitted to the speech recognition server 230. The speech zone data is speech-recognized in the speech recognition server 230, and in block 838, text data, which is the result of recognition, is returned from the speech recognition server 230. In block 840, based on the result of recognition, what is displayed in the balloon 506 of the recording view 210-2 is updated. Accordingly, as long as the speech zone data is stored in the queue 376, the speech recognition continues even if the recording is finished.

Since the recognition result obtained at the time of recording is saved together with the speech zone data, the recognition result may be displayed at the time of playback. Also, when the recognition result could not be obtained at the time of recording, the speech zone data may be recognized at the time of playback.

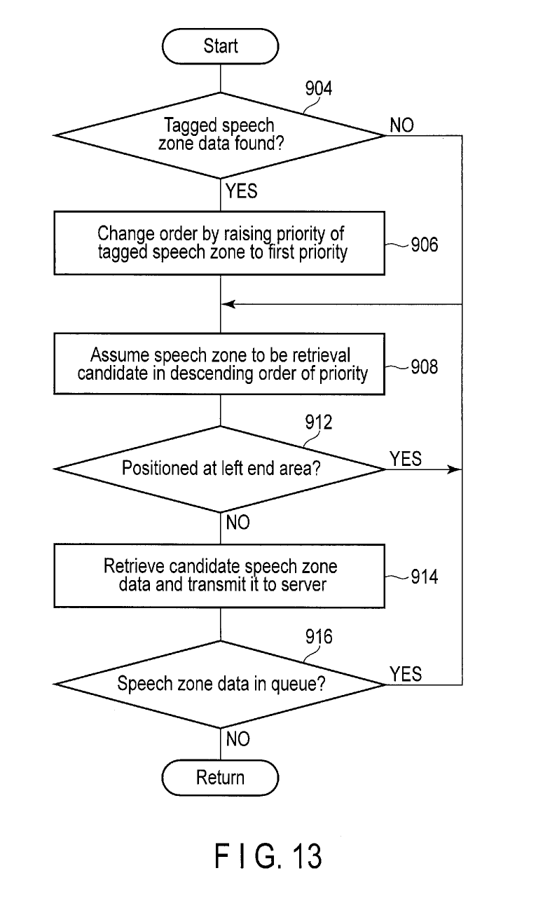

FIG. 13 is a flowchart showing an example of retrieval of speech zone data from the priority control module 380 indicated in block 836. In block 904, it is determined whether tagged speech zone data is stored in the queue 376. If such data is stored, in block 906, the tagged speech zone is given first priority, and after the order of priority of each of the speech zones has been changed, block 908 is executed. Even in the case where tagged speech zone data is not stored in block 904, block 908 is executed.

In block 908, a speech zone having the highest priority is assumed to be a candidate for retrieval. In block 912, it is determined whether the position of the bar 502 indicating the retrieval candidate speech zone within the screen is at the left end area or not. The display position of the speech zone bar being at the left end area means that the speech zone bar is immediately disappeared from the screen. Therefore, it is possible to determine that the necessity of speech recognition for this speech zone is low. Accordingly, if an area where the speech zone bar is displayed is at the left end, speech recognition processing for this speech zone bar is omitted and the next speech zone is assumed to be a retrieval candidate in block 908.

If an area where the speech zone bar is displayed is not at the left end, data of the retrieval candidate speech zone is retrieved from the priority ordered queue 376 and transmitted to the speech recognition server 230 in block 914. After that, in block 916, it is determined whether speech zone data is stored in the priority ordered queue 376 or not. If the speech zone data is stored, the next speech zone is assumed to be a retrieval candidate in block 908. If the speech zone data is not stored, the processing returns to the flowchart of FIG. 12, and block 838 (receipt of recognition result) is executed.

According to the processing of FIG. 13, speech recognition for those whose display time is short even if they are speech-recognized is omitted. Further, on the contrary, since the speech zone having high importance is speech-recognized preferentially, a speech recognition result is displayed immediately.

As described above, according to the first embodiment, since only the necessary speech data is speech-recognized during acquisition (recording) of audio data which takes a long time such as speech in a meeting, a reduction of a waiting time for speech recognition result can be expected. In addition, since speech which is not suitable for speech recognition is excluded from the speech recognition processing, not only can the recognition accuracy be expected, but occurrence of useless processing and unnecessary processing time can also be eliminated. Further, since the speech zones can be speech-recognized in the order of the user's preference instead of the order of recording, the substance of speech that the user thinks is important can be checked quickly, for example, and the meeting can be retraced more effectively. In addition, when displaying the speech zones and recognition results thereof in chronological order, speech recognition for a speech zone displayed at a position which will be soon disappeared from the display area can be omitted, and the recognition results can be effectively displayed within the limited screen and the limited time.

Since the processing of the present embodiment can be realized by a computer program, it is possible to easily realize an advantage similar to that of the present embodiment by simply installing a computer program on a computer by way of a computer-readable storage medium having stored thereon the computer program, and executing this computer program.

The present invention is not limited to the above embodiment as it is but the constituent elements can be modified variously without departing from the spirit of the invention when implemented. Also, various inventions can be achieved by suitably combining the constituent elements disclosed in the above embodiment. For example, some constituent elements may be deleted from the entire constituent elements shown in the embodiment. Further, constituent elements of different embodiments may be combined suitably.

For example, as the speech recognition processing, an unspecified-speaker-type learning server system speech recognition processing has been described. However, the speech recognition engine 324 within the tablet PC 10 may perform the recognition processing locally without using a server, or in the case of using a server, specified-speaker-type speech recognition processing may alternatively be adopted.

The display forms of the recording view and the playback view are not in any way restricted. For example, the display showing the speech zones in the recording view and the playback view is not limited to one using a bar and may be a form of displaying waveforms as in the home view as long as the waveform of a speech zone and the waveform of the other zones can be distinguished from each other. Alternatively, in the views, the waveform of a speech zone and that of the other zones do not have to be distinguished from each other. That is, since recognition result is additionally displayed for each of the speech zones, even if all the zones are displayed in the same way, the speech zones can be identified based on the display of the recognition result.

While speech recognition is carried out by first storing the speech zone data in the priority ordered queue, the way of speech recognition is not limited to the way described. That is, the speech recognition may be carried out after storing the speech zone data in an ordinary first-in, first-out register in which priority control is disabled.

Based on a restriction on the display area of the screen and/or a processing load on a server, speech recognition processing for some items of speech zone data stored in the queue is skipped. However, instead of skipping the data in units of speech zone data, only the head portion of each item of the speech zone data or the portion displayed in the balloon may be speech-recognized. After displaying only the respective head portions, if time permits, the remaining portions may be speech-recognized in order from the speech zone that is most close to the current time, and the display may be updated.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to record a sound from a microphone and recognize a speech, the apparatus comprising:
a receiver configured to receive a sound signal from the microphone, wherein the sound comprises a first speech period and a second speech period; and
circuitry configured to:
display on a screen a first object indicating the first speech period, and a second object indicating the second speech period after the first speech period during recording of the sound signal;
perform speech recognition on the first speech period to determine a first character string comprising the characters in the first speech period;
display the first character string on the screen in association with the first object;
perform speech recognition on the second speech period to determine a second character string comprising the characters in the second speech period; and
display the second character string on the screen in association with the second object,
wherein the circuitry configured to further perform speech recognition on at least a part of the first speech period and at least a part of the second speech period in an order of priority based on display positions of the first object and the second object on the screen.

2. The apparatus of claim 1, wherein when the first speech period or the second speech period is designated, the circuitry configured to further perform the speech recognition on at least a part of the first speech period or at least a part of the second speech period with a higher priority regardless of the display positions of the first object and the second object on the screen.

3. The apparatus of claim 1, wherein the circuitry is configured to display on the screen at least a part of the first character string obtained by the speech recognition in the first speech period or at least a part of the second character string obtained by the speech recognition in the second speech period.

4. The apparatus of claim 1, wherein the circuitry is configured to display the first character string corresponding to a length of the first speech period on the screen, and display the second character string corresponding to a length of the second speech period on the screen.

5. The apparatus of claim 1, wherein the circuitry is configured to display either the first object and the second object or the first character string and the second character string indicative of status of the speech recognition of unprocessed, being processed, or processing completed.

6. A method for an electronic apparatus configured to record a sound from a microphone and recognize a speech, the method comprising:
receiving a sound signal from the microphone, wherein the sound comprises a first speech period and a second speech period;
displaying on a screen a first object indicating the first speech period, and a second object indicating the second speech period after the first speech period during recording of the sound signal, the first object and the second object;
performing speech recognition on the first speech period to determine a first character string comprising the characters in the first speech period;
displaying the first character string on the screen in association with the first object;
performing the speech recognition on the second speech period to determine a second character string comprising the characters in the second speech period;
displaying the second character string on the screen in association with the second object; and
performing the speech recognition on at least a part of the first speech period and at least a part of the second speech period in an order of priority defined based on display positions of the first object and the second object on the screen.

7. The method of claim 6, wherein when the first speech period or the second speech period is designated, further performing the speech recognition on at least a part of the first speech period or at least a part of the second speech period with a higher priority regardless of the display positions of the first object and the second object on the screen.

8. The method of claim 6, further comprising:
displaying on the screen at least a part of the first character string obtained by the speech recognition in the first speech period or at least a part of the second character string obtained by the speech recognition in the second speech period.

9. The method of claim 6, further comprising:
displaying the first character string corresponding to a length of the first speech period on the screen; and
displaying the second character string corresponding to a length of the second speech period on the screen.

10. The method of claim 6, further comprising:
displaying either the first object and the second object or the first character string and the second character string indicative of status of the speech recognition of unprocessed, being processed, and processing completed.

11. A non-transitory computer-readable storage medium having stored thereon a computer program which is executable by a computer configured to record a sound from a microphone and recognize a speech, the computer program comprising instructions capable of causing the computer to execute functions of:
receiving a sound signal from the microphone, wherein the sound comprises a first speech period and a second speech period;
displaying on a screen a first object indicating a first speech period, and a second object indicating a second speech period after the first speech period during recording of the sound signal, the first object and the second object;
performing speech recognition on the first speech period to determine a first character string comprising the characters in the first speech period;
displaying the first character string on the screen in association with the first object;
performing speech recognition on the second speech period to determine a second character string comprising the characters in the second speech period;
displaying a second character string on the screen in association with the second object; and
performing the speech recognition on at least a part of the first speech period and at least a part of the second speech period in an order of priority defined based on display positions of the first object and the second object on the screen.

12. The storage medium of claim 11, wherein when the first speech period or the second speech period is designated, further performing the speech recognition on at least a part of the first speech period or at least a part of the second with a higher priority regardless of the display positions of the first object and the second object on the screen.

13. The storage medium of claim 11, further comprising:
displaying at least a part of the first character string obtained by the speech recognition of the first speech period or at least a part of the second character string obtained by the speech recognition of the second speech period on the screen.

14. The storage medium of claim 11, further comprising:
displaying the first character string corresponding to a length of the first speech period on the screen; and
displaying the second character string corresponding to a length of the second speech period on the screen.

15. The storage medium of claim 11, further comprising:
displaying either the first object and the second object or the first character string and the second character string indicative of status of the speech recognition of unprocessed, being processed, or processing completed.
